(19) United States
(12) Patent Application Publication
(10) Pub. No.: US 2006/0122545 A1
(43) Pub. Date: Jun. 8, 2006

(54) Eyesight and hair recovery device, and medical treating method

(76) Inventor: Shoichi Terui, Iwate (JP)

Correspondence Address: Roth & Goldman, Suite 707, 523 West 6th Street, Los Angeles, CA, 90014, US

(21) Appl. No.: 10/521,341

(22) PCT Filed: Jul. 15, 2003
(86) PCT No.: PCT/JP03/08959

§ 371 Date: Aug. 4, 2005

(30) Foreign Application Priority Data
Jul. 15, 2002 (JP) 2002-249771
Jul. 15, 2003 (JP) 2003-305418

(51) Int. Cl. A61H 1/00

(52) U.S. Cl. 601/72; 601/80; 601/69; 601/67

(57) ABSTRACT

The present invention is basically directed to relaxing deep parts near eyeballs, back of bone, muscle attached to protruded portion of eye bones, temple, back of head, engaging muscle of upper and lower teeth, and head skin using a circulation force, not a simple press or a vibration, for thereby achieving a good eyesight and preventing whitening of hair. Namely, in the apparatus according to the present invention, a transfer with one side fixed is designed to press a portion needing a therapy.

### BACKGROUND OF THE INVENTION

1. Field of the Invention

The present invention relates to an eyesight and hair recovery apparatus and a therapy method using the same, and an improved eyesight and hair recovery apparatus and a therapy method using the same capable of activating a movement of a human body based on a massage effect in such a manner that a transfer driven by a rotation, fluctuation or vibration presses on a part of a human body.

2. Description of the Background Art

In the conventional art, in order to enhance eyesight, people are told to see stars in the sky or massage eyeballs using hands. Ultrasonic waves are emitted to the surrounding portions of eyeballs or a vibrating protrusion is attached to glasses.

However, none of the above conventional method softens stiffness of muscle around eyeballs and effectively cures a transfer problem of visual nerves due to the stiffness.

In addition, the conventional art is directed to simply vibrating the skin.

### DETAILED DESCRIPTIONS OF THE INVENTION

In the present invention, a transfer 1 is formed in various shapes, a deep muscle portion around eyeballs, backside of bones 1 and 2, a muscle portion at protruded portions of bones near the eyeballs, temple portions, back of head, muscle engaged with upper and lower teeth, and skins are massaged by rotational forces, not a simple press and vibration for thereby maximizing a massage effect.

In the present invention, a stiff muscle or hardening at surrounding portions of eyeballs are softened with rotational massage. Therefore, a transfer problem of visual nerves and a restriction of secretion liquid are overcome, so that it is possible to achieve a desired effect.

The radius of rotation is about 0.1 mm˜3 mm, and the number of rotations is 50˜3800 per minute for thereby maximizing the massage effect.

In addition, when the hardened muscle is softened by providing a rotation force to the muscle capable of activating the temple and upper and lower teeth, it is possible to enhance a desired smooth movement of eyeballs, and a visible range is enhanced. Furthermore, it is possible to increase a chewing force between the upper and lower teeth.

When the present invention is adapted to the back of head, it is possible to achieve a support effect with respect to eyesight. In order to obtain the same effect using the transfer driven by a repulsive force of one side, vibrations are transferred to hands or portion to be fixed, so that the noise is increased. Therefore, the vibration force gets weakened, so that it is impossible to achieve a desired effect because the vibrating force is escaped from the necessary portion.

When the circulating transfer 1 is fixed at one side and is used, the transfer 1 is capable of providing a strong force to a desired portion of a human body.

In the same manner, a blood circulation effect with respect to head skin is enhanced, and it is possible to achieve a black hair and recovery. As cited in claim 1, as shown in FIG. 1, its one side is placed on ground, floor, wall or other portions. It can be supported using hands. The transfer 1 presses the surrounding portions of eyeballs. When it presses on the skins near eyelids, fatigue disappears. As shown in FIG. 1, it is possible to significantly enhance eyesight. The present invention is capable of achieve a wider range effect with respect to various eye diseases due to astigmatism, strabismus, myopia and bad blood circulation. The front end of the same is made thin for a deep operation between the eyeballs and the bones 1 and 2. As cited in claims 3, 4 and 5, the stiffened muscle of each part of the human body are massaged as described above, so that the movement of each part get smooth and are strengthened. The pressing transfer is formed of hard materials. In order to achieve a smooth movement of eyeballs, as shown in FIG. 8, the muscles near the temple get pressed.

The circulating transfer 1 presses the stiffened muscle 12 of the back of the head for thereby achieving a massage effect. As the muscle gets normal operations, the eyesight is enhanced.

As cited in claim 6, since the circulating transfer 1 is adapted, it relates to FIG. 11. As cited in claims 1, 2, 3, 4, 5, 11, 12, what one side is fixed includes a method for fixing with one hand, holding a certain item such as a cell phone using one hand. In another example, it may be placed on floor, wall or mat.

When the transfer 1 is circulated, the transfer 1 effectively massages the stiffened muscle for thereby achieving a short time relaxing. As cited in claim 7, the circulating transfer 1 or the transfer 1 driven by the repulsive force of the rotational member get integral with the cell phone, so that it is possible to enhance convenience of carriage.

The driving principle of the apparatus having the transfer 1 driven by a repulsive force of the rotation member is shown in FIG. 10. When the rotational member 16 contacts by the motor 17, it may lose balance due to a centrifugal force of an eccentric weight 15 for thereby starting vibrating. The transfer 1 uses the above vibrations. The above operations are shown in FIGS. 10 and 11.

Claim 8 relates to FIG. 9. As cited therein, it is possible to achieve the same eye sight as the eyesight before the therapy by improving the eyesight. The muscle of eyes is relaxed, and a focus matching ability of lens, so that the eyesight is enhanced.

The present invention relates to a method of repeatedly performing the above operation and enhancing a desired eyesight.

Claim 9 relates to FIG. 10. It is circulated with a motor 17. An eccentric weight 15 is installed away from the center of the rotation member 16. The balance is lost due to the eccentric force, so that a desired vibration is generated. Since the transfer 1 is integral with the motor 17, it cooperates and starts vibrating.

Claim 10 includes all possible methods for holding or supporting it using hands, assuming one side as a stator. For example, in the case that the casing 9 is caught by hands, and the circulating transfer 1 is contacted with the affected part, since vibrations are transferred to hands, it is impossible to perform a desired therapy. At this time, a stabilization weight 8 is installed for thereby preventing the hands from being trembled, so that it is possible to fully press the vibrations. In the case that the muscle capable of moving the upper and lower teeth and the stiff muscle of temple are massaged, a desired big effect can be achieved. It is also effective to the massage of head skin. It is possible to easily carry the product.

Claim 11 relates to the use of massage apparatus shown in FIG. 2. The transfer 1 massages the head skin through hairs. It can be changed in all directions as the support part is caught by hands. The above construction relates to FIG. 2. The transfer 1 is circulated.

Claim 12 relates to a head skin massage apparatus as shown in FIG. 7.

As cited in claim 13, when a massage apparatus is adapted for a head back part massage, a plurality of transfers 1 are installed. Both sides of the transfer 1 get higher, and the center portion of the same gets lower. A certain pressure is applied based on the shape of head, so that the transfer 1 is circulated for thereby massaging the back part of head. In this case, it is possible to achieve a desired massage effect for a short time period. It is desirable to adjust the shape of the transfer 1 based on the shapes of a head, leg, arm and waist, so that it is possible to effectively massage the above portions.

As cited in claim 14, the height of the transfer may be changed with respect to the height of the back part of head, and then the transfer 1 is circulated and massages the back part of the head. When the user lies in horizontal shape, it is possible to effectively massage the entire portions of head. In this case, it is used in a horizontal posture. The handle part 10 may be lifted up in another embodiment of the use. The above construction and operation relate to FIGS. 4, 5, 6, 7. In the present invention, it is possible to cure muscle capable of moving the portions near the temple and the upper and lower teeth, head skin and face part. Namely, the present invention relates to multiple purposes massage apparatus. The occurrence of the rotational force is shared, and the transfer 1 can be installed based on the portion to be cured.

### BRIEF DESCRIPTION OF DRAWINGS

FIG. 1 is a view of a therapy of an affected part based on a circulating transfer;

FIG. 2 is a view illustrating a massage apparatus that may be caught by hands by a circulating transfer;

FIG. 3 is a view illustrating a rotation of a transfer;

FIG. 4 is a perspective view illustrating a massage apparatus capable of massaging and curing a head part, a head and a leg;

FIG. 5 is a perspective view illustrating a massage apparatus capable of curing muscle capable of moving temple and upper and lower teeth;

FIG. 6 is a perspective view illustrating a massage apparatus having a transfer capable of curing eyeballs;

FIG. 7 is a perspective view illustrating a head skin massage apparatus;

FIG. 8 is a view illustrating the construction;

FIG. 9 is a view illustrating an example of therapy;

FIG. 10 is a perspective view illustrating a transfer vibrating by a repulsive force of a rotation member;

FIG. 11 is a lateral view of a combination that a transfer is adapted to a cell phone; and

FIG. 12 is a lateral view of an eyeball therapy using a massage apparatus having a safety member.

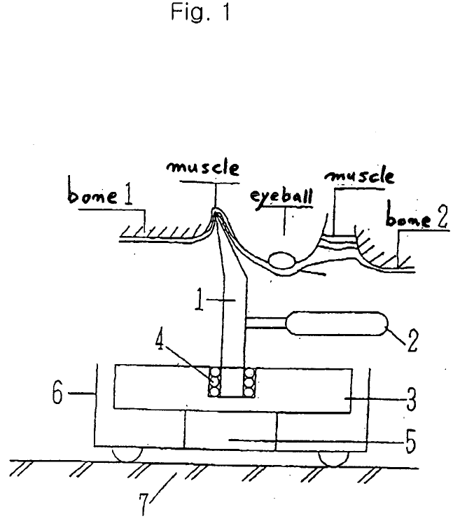

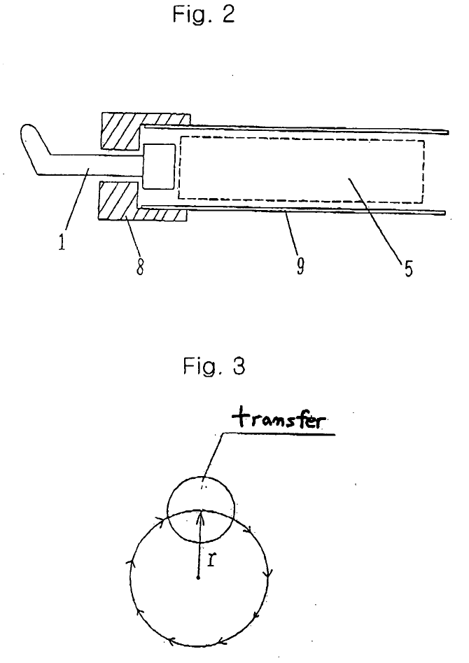

### DESCRIPTION OF REFERENCE NUMERALS

1: transfer

2: handle

3: rotation plate

4: bearing

5: rotation generation part

6: casing

7: floor

8: stabilization weight

9: casing

10: handle part

11: safety guard

12: back of head

13: temple

14: muscle capable of moving upper and lower teeth

15: weight

16: rotation member

17: motor

18: cell phone

19: bone lower protection part

20: safety member

### EMBODIMENTS

A transfer 1 is designed to achieve a circulation without a rotation itself for thereby achieving a good feeling and safety. In other words, the transfer 1 is not circulated, namely, is moved with circulation in one track form.

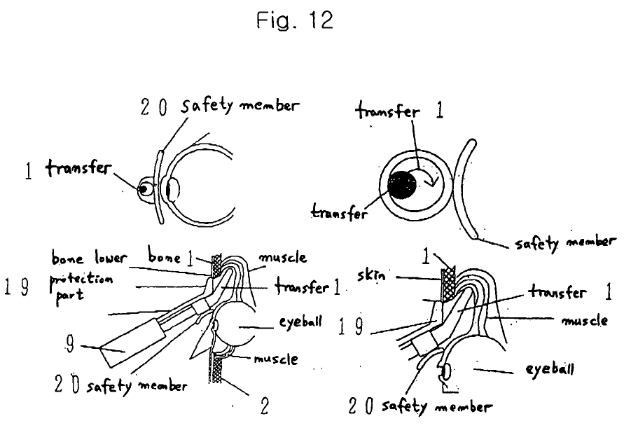

As shown in FIG. 12, the transfer 1 includes a bone lower side protection part 19 for preventing the transfer 1 from being moved into a deep part, and an eye part massage apparatus having a safety member 2 for an eyeball protection.

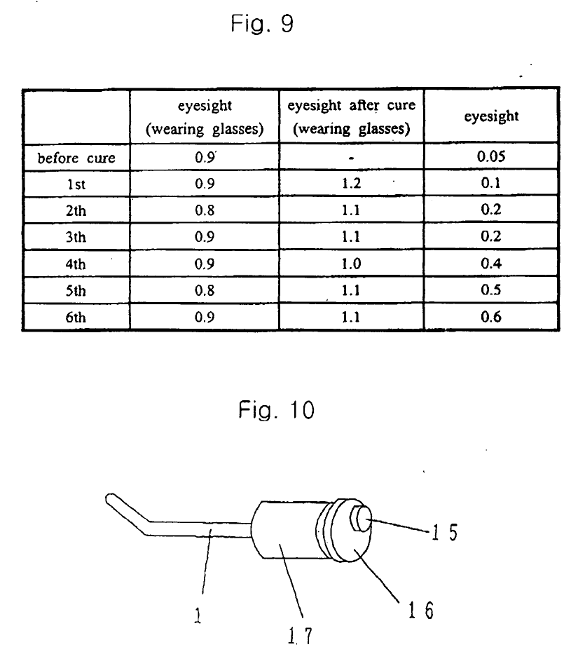

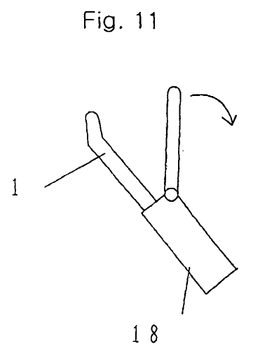

FIG. 9 shows a performance improved to an eyesight of 0.05˜0.6 that has not been used for 6 weeks.

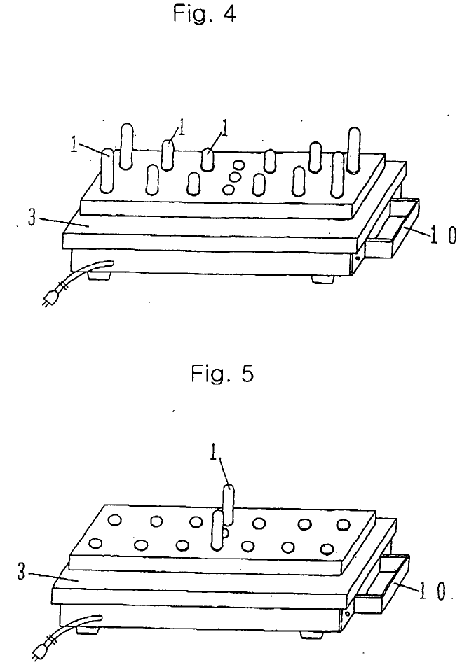

FIGS. 4, 5 and 6 shows the apparatus that are used for therapy. The apparatus massages a back of head, temple, muscle capable of moving upper and lower teeth, and eye part. It is possible to achieve a desired effect even when massaging only the eye part.

The material and shape of the transfer 1 can be determined based on the portion to be cured. The material and shape of the same are not limited thereto. Therefore, the detailed description is omitted.

As cited in claims 1, 2, 3, 4, 5, 10, 11, what one side is fixed means it is fixed at a certain member using hands except for floor. It may be fixed at any portion of the structure.

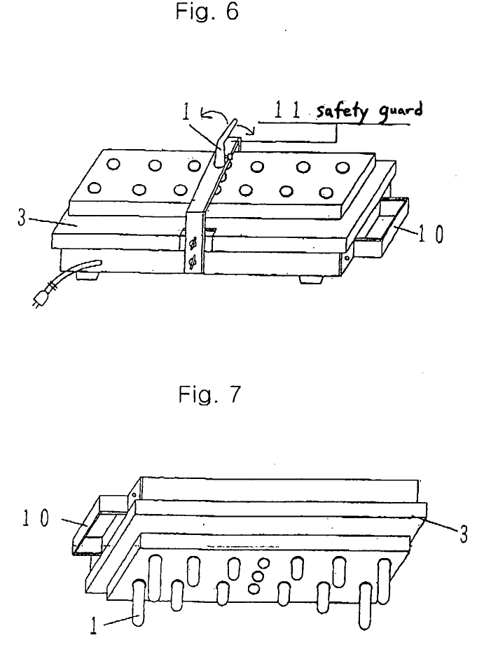

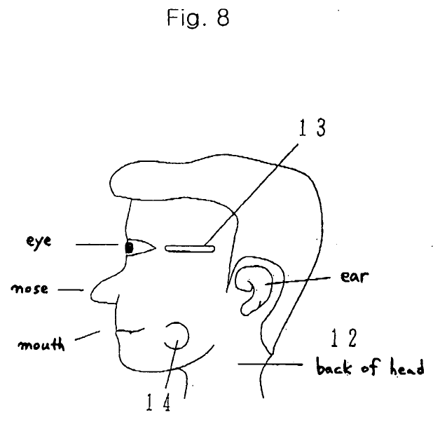

As shown in FIG. 6, the transfer 6 is circulated and used. In this case, the safety guard is fixed at the massage apparatus, and the transfer 6 may be circulated in a structure circulating in a circular hole formed in the safety guard. The safety guard is adapted to prevent over radius of rotation. The safety guard 11 is detachable.

The effects of the present invention will be described in the following.

### INDUSTRIAL USABILITY

1. Effects With Respect to Eyes

It is very effective to myopia, strabismus, weak eyesight, cataract, narrow eyesight, bad visual angle, trembling of eyelid or bad feeling, and uneasy to eyelid

2. Got Darkened Hair

3. Effects in Life

In addition, it is possible to achieve prevent sleepiness when a person drives a car for a long time. The workability is enhanced for thereby achieving a good writing. Since it is possible to quickly read traffic signal and character, a safe driving can be achieved. An easier computer work is obtained. A sleepiness prevention of pilot is obtained. It is possible to see a detailed expression on face, talking with someone, for thereby achieving fun talking. Heads get smart. There are too many advantages.

What is claimed is:

1. An apparatus that is characterized in that a circulating transfer of which one side is fixed presses a portion needing a therapy.

2. The apparatus of claim 1, wherein said transfer circulating with one side fixed presses a surrounding portion of eyes.

3. The apparatus of claim 1, wherein said transfer circulating with one side fixed presses a surrounding portion of temple.

4. The apparatus of claim 1, wherein said transfer circulating with one side fixed presses an engaging muscle between upper and lower teeth.

5. The apparatus of claim 1, wherein said transfer circulating with one side fixed presses a surrounding portion of back of head.

6. An massage apparatus that is characterized in that a driving apparatus driving a circulating transfer is installed at a cell phone, and said transfer presses a portion needing a therapy.

7. An massage apparatus that is characterized in that a transfer driven by a repulsive force of a rotation member is provided at a cell phone, and said transfer presses a portion needing a therapy.

8. A method for maintaining the same glasses eyesight as the previous eyesight by changing a low power glasses after the eyesight is enhanced.

9. A massage apparatus that is characterized in that a transfer driven by a repulsive force of a rotation member presses a portion needing a therapy.

10. The apparatus of either claim 1 or 6, wherein said circulating transfer having a stabilization weight of which one side is fixed presses a portion needing a therapy.

11. The apparatus of claim 1, wherein a circulating transfer with one side fixed presses on a head skin for thereby massaging a head skin.

12. The apparatus of claim 1, wherein said transfer is provided in multiple numbers, and both sides of the same are designed to get longer, and the center portion of the same is designed to get shorter, wherein the transfer presses a head skin, holding a handle installed therein.

13. The apparatus of claim 1, wherein said transfer is provided in multiple numbers, and both sides of the same are designed to get higher, and the center portion of the same is designed to get lower, wherein the transfer presses a head skin, holding a handle installed therein.

14. The apparatus of claim 1, wherein a plurality of transfers are provided, the length of the transfer is determined to match with the upper side of the head, and the length of the transfer is set so that one side of the same is matched with the back of head, and the transfer is designed to press the temple, and the transfer is designed to press the muscle capable of moving the upper and lower teeth, and the transfer presses the eye part, and the transfer capable of achieving a desired massage on the entire above portions or a part of the same is cooperated with a rotation generation part.
